(19) United States
(12) Patent Application Publication
(10) Pub. No.: US 2019/0337582 A1
(43) Pub. Date: Nov. 7, 2019

(54) MOBILE OBSTACLE COURSES

(71) Applicants: Robin Whincup, Port Charlotte, FL (US); Michael Robin Whincup, Bradenton, FL (US)

(72) Inventors: Robin Whincup, Port Charlotte, FL (US); Michael Robin Whincup, Bradenton, FL (US)

(21) Appl. No.: 16/403,407

(22) Filed: May 3, 2019

Related U.S. Application Data
(60) Provisional application No. 62/667,248, filed on May 4, 2018.

(51) Int. Cl. B62D 63/06; B60P 3/025; E04H 3/28

(52) U.S. Cl. CPC B62D 63/061; B60P 3/025; A63B 9/00; A63G 2200/00; E04H 3/28

(57) ABSTRACT

Mobile obstacle courses include an expandable structure that is supported by a wheeled chassis and contains a plurality of obstacles therein. The expandable structure is configured to move between a transport state and a deployed state and includes: a central obstacle area and an outer obstacle area that is connected to the central obstacle area in the transport state and in the deployed state. In the transport state, the expandable structure has a first footprint. In the deployed state, the expandable structure has a second footprint that is larger than the first footprint.

### CROSS-REFERENCE TO RELATED APPLICATION

This application claims the benefit of Provisional Application No. 62/667,248 filed May 4, 2018, the entire disclosure of which is hereby incorporated by reference herein.

### BACKGROUND

The present disclosure relates generally to obstacle courses (for example, ninja courses), and in particular mobile obstacle courses that may be transported by a vehicle and quickly deployed.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

One aspect of the present disclosure regards a mobile obstacle course. The obstacle course is at least partially supported by a chassis and is variable between a first state and a second state. The obstacle course includes a first obstacle area and a second obstacle area that is connected to the first obstacle area in the first and second states. In the first state, the obstacle course has a first footprint. In the second state, the obstacle course has a second footprint that is greater than the first footprint.

A second aspect of the present disclosure regards a mobile entertainment system that includes an obstacle course that is variable between a transport state and a deployed state. The obstacle course includes a central obstacle section that is movably connected with a lateral obstacle section. The lateral obstacle section includes at least one side that is associated with a floor. In the transport state, the obstacle course has a road-legal transport volume. In the deployed state, the obstacle course has a deployed volume that is at least two times greater than the road-legal transport volume.

A third aspect of the disclosure regards an obstacle course. The obstacle course includes an expandable course that is variable between a transport state and a deployed state. The expandable course includes a first obstacle section that is movably associated with a second obstacle section. The first obstacle section includes a first floor, and the second obstacle section includes a second floor. In the transport state, the first floor and the second floor are within fifteen degrees of perpendicular with each other. The expandable course is configured to fit within an envelope having a width of approximately ten feet, a height of approximately fifteen feet, and a length of approximately sixty feet.

A fourth aspect of the disclosure regards a method of entertaining. The method includes transporting an obstacle course on a trailer. The obstacle course is configured to have a first footprint and a second footprint that is at least twice as large as the first footprint. The method further includes transforming the obstacle course from a transport configuration in which it has the first footprint to a deployed configuration in which it has the second footprint and a plurality of participant-facing obstacles contained upon the second footprint. The plurality of participant-facing obstacles contained upon the second footprint in the deployed configuration include all participant-facing obstacles of the obstacle course. The method further includes a step of opening the obstacle course for use.

One or more aspects of the present disclosure provide several advantages, including expandability and mobility of an obstacle course. More particularly, the obstacle courses disclosed in this application are expandable from a first footprint (or first volume) to a larger second footprint (or a second volume). Also, the obstacle courses disclosed in this application are configured to be transported by a vehicle. Further, the obstacle courses disclosed in this application are configured for rapid deployment. Together, these features provide exciting, challenging, and self-contained obstacle courses that may be transported by a single vehicle, for example to an event site. The obstacle courses can be quickly set up so that participants can “challenge” the obstacle courses soon after arrival at the event site.

Other systems, methods, features and advantages of the present disclosure will be, or will become, apparent to one with skill in the art upon examination of the following figures and detailed description. It is intended that all such additional systems, methods, features and advantages be within the scope of the present disclosure, and be encompassed by the following claims.

### DESCRIPTION OF THE DRAWINGS

The present disclosure can be better understood with reference to the following drawings, description, and Appendices (which relate to the obstacle course of FIGS. 1A-B, 10A-H, and 11-13). The components in the figures are not necessarily to scale, emphasis instead being placed upon illustrating the principles of the present disclosure. Moreover, in the figures, like referenced numerals designate corresponding parts throughout the different views.

FIG. 1A shows a perspective view of a first embodiment of an obstacle course in a deployed state in accordance with the present disclosure.

FIG. 1B shows a schematic rear view of the obstacle course of FIG. 1A in a transport state.

FIG. 2A shows a schematic rear view of an alternative embodiment of an obstacle course in a transport state in accordance with the present disclosure.

FIG. 2B shows the obstacle course of FIG. 2A in a deployed state.

FIG. 3A shows a schematic top view of an alternative embodiment of an obstacle course in a transport state in accordance with the present disclosure.

FIG. 3B shows the obstacle course of FIG. 3A in a deployed state.

FIG. 4A shows a schematic rear view of an alternative embodiment of an obstacle course in a transport state in accordance with the present disclosure.

FIG. 4B shows a schematic rear view of the obstacle course of FIG. 4A in a partially deployed state.

FIG. 4C shows a schematic top view of the obstacle course of FIGS. 4A-B in a fully deployed state.

FIG. 5 shows a perspective view of an embodiment of a chassis that may be used with obstacle courses of FIGS. 1A-4C.

FIG. 6 shows a perspective view an embodiment of a wheel carriage that may be used with obstacle courses of FIGS. 1A-4C.

FIG. 7 shows a perspective view of an embodiment of a floor that may be used with obstacle courses of FIGS. 1A-4C.

FIG. 8 shows a schematic side view of an embodiment of a side portion of a frame that may be used with obstacle courses of FIGS. 1A-4C.

FIG. 9A shows a schematic side view of one embodiment of an end portion of a frame that may be used with obstacle courses of FIGS. 1A-4C.

FIG. 9B shows a perspective view of another embodiment of an end portion of a frame in accordance with the present disclosure.

FIG. 9C shows a perspective view of yet another embodiment of an end portion of a frame in accordance with the present disclosure.

FIGS. 10A-H show perspective views of the obstacle course of FIGS. 1A-B transitioning from a transport state to a deployed state in accordance with the present disclosure.

FIG. 11 shows various obstacles that may be utilized in obstacle courses of the present disclosure.

FIG. 12 shows additional obstacles that may be utilized in obstacle courses of the present disclosure.

FIG. 13 shows additional obstacles that may be utilized in obstacle courses of the present disclosure.

The drawings described herein are for illustration purposes only and are not intended to limit the scope of the present disclosure in any way.

### DETAILED DESCRIPTION

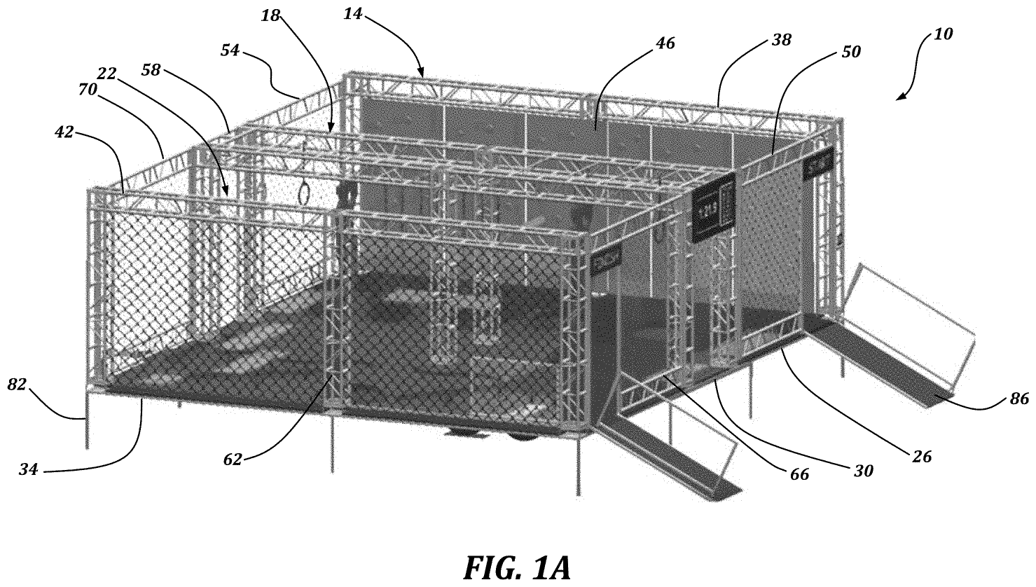

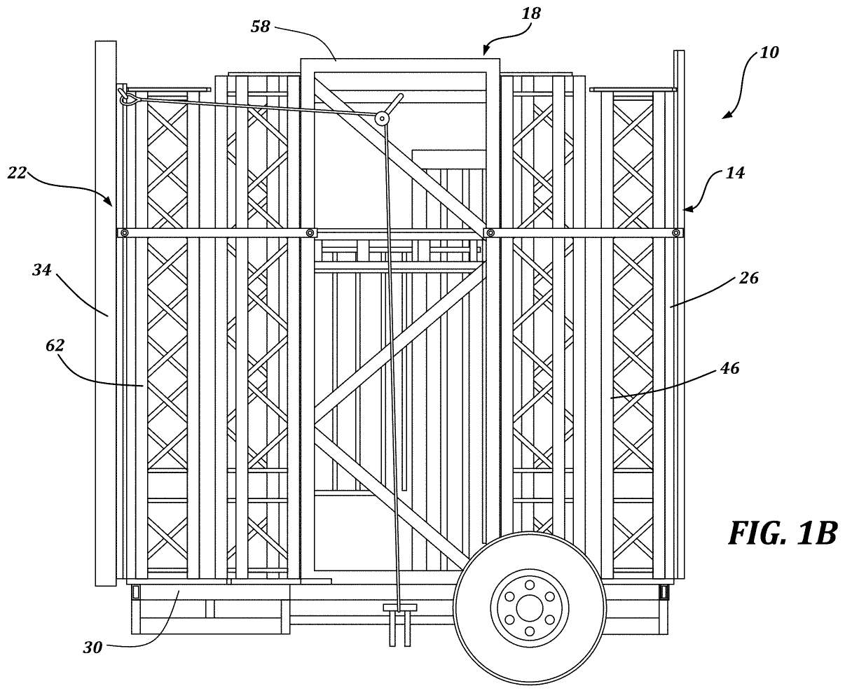

FIG. 1A illustrates an obstacle course 10 that is configured for mobility and rapid deployment. The obstacle courses described in this application may include a number of obstacles, for example one or more climbing walls, angled hop steps, parkour blocks, dome hops, hand bombs, cheese boards, climbing rings, folding platforms, dangle discs, balance beams, see saws, warped walls, smoke cannons, and other obstacles. Preferably, the obstacle course may include a relatively large number of obstacles in order to make the course more challenging and appealing to participants, and to present additional revenue opportunities for the owner. The selection and number of obstacles may vary significantly between embodiments, and may be selected for a particular age group, ability group, or other group. To increase enjoyment by participants and spectators and/or for other commercial or technical advantage, the obstacle course may include additional features, for example a timing system, a scoreboard, a video monitor or television, other audiovisual equipment, additional electronic components, advertisements, graphics, a spectator window, safety nets, other safety features, and other features. The obstacle courses described herein may contain numerous combinations and configurations of obstacles and features. Further, the obstacle courses may be variable between a relatively small transport state in which the obstacle course is configured to move or to be moved by a vehicle, and a relatively large deployed state in which the obstacle course is configured for use.

The obstacle courses described herein may include a plurality of sections that are structurally associated with one another to enable movement between a first state (for example, a transport state) and a second state (for example, a deployed state), as described below. In both the first state, second state, and intermediate states, the major elements of the obstacle course structure (e.g., sections, floors, walls, frames, etc.) may remain contained within and/or upon the obstacle course. Each section of the obstacle course may include an obstacle area that is configured to receive and/or support one or more obstacles and/or features as described above. For example, the obstacle course may include two, three, four, five, six, or a greater number of sections, with each section configured to receive and/or support three, four, five, six, or a greater number of obstacles.

The sections of the obstacle course may have a number of different configurations. For example, the obstacle course 10 of FIGS. 1A-B includes a first section 14, a second section 18, and a third section 22. The sections 14, 18, 22 are operably connected in a lateral wing configuration, which enables the obstacle course 10 to transition from a transport state (as shown in FIG. 1B) to a deployed state by rotating the first and third sections 14, 22 away from the central second section 18 (e.g., via horizontal hinges). For example, section 18 may have a rectangular floor with two hinges that are parallel to one another and attached along the longitudinal sides of the rectangular floor. The hinges are attached to sections 14 and 22 so that sections 14 and 22 can rotate and/or pivot about the longitudinal axes of the hinges.

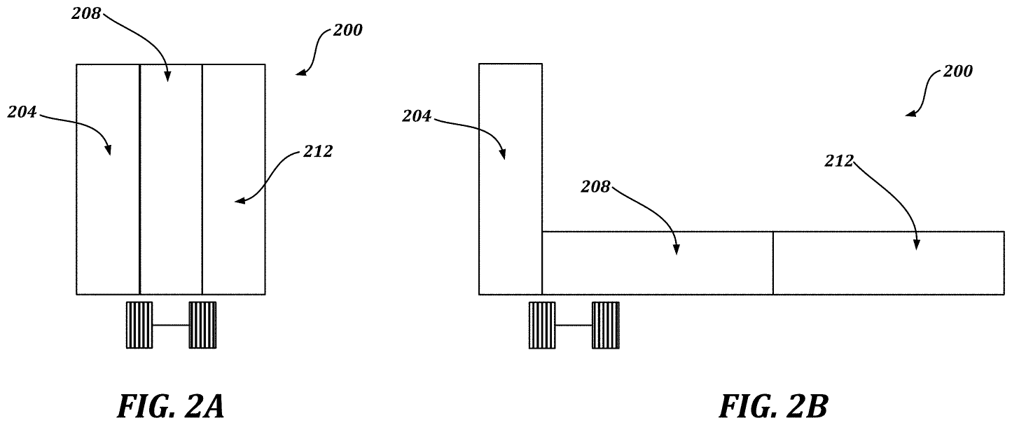

In the alternative embodiment of FIGS. 2A-B, an obstacle course 200 includes a first section 204, a second section 208, and a third section 212 in a lateral serial configuration. To transition from a transport state to a deployed state, the second section 208 unfolds from the first section 204, and the third section 212 unfolds from the second section 208.

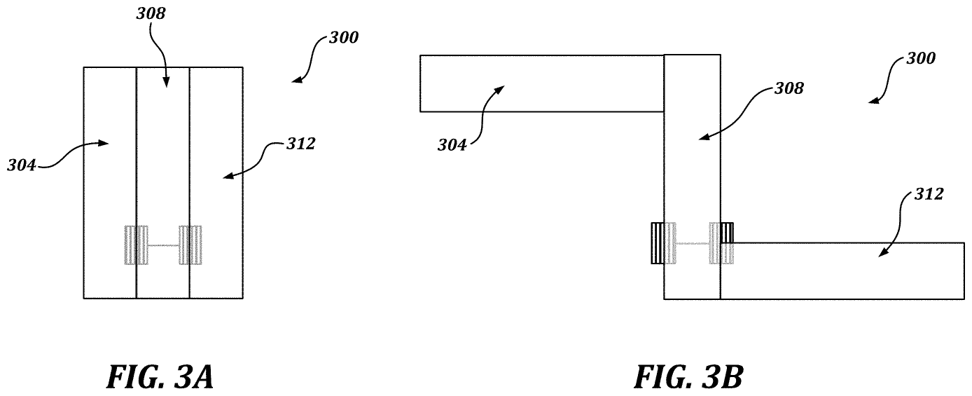

In the alternative embodiment of FIGS. 3A-B, an obstacle course 300 has a vertical wing configuration, in which a first section 304 and a third section 312 rotate away from the central second section 308 via vertical hinges.

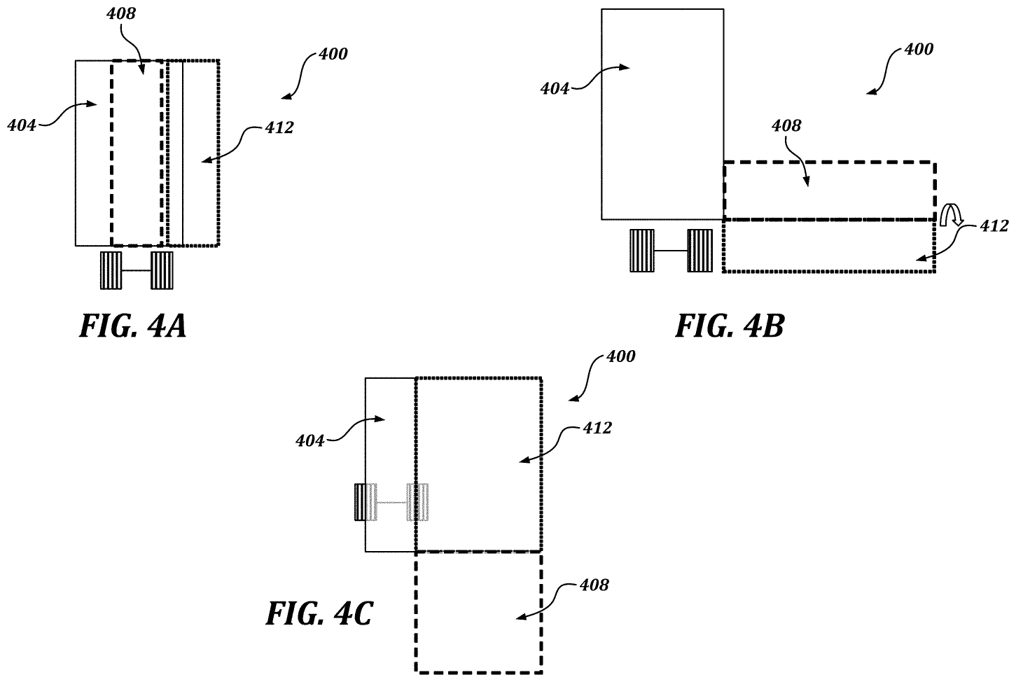

In the alternative embodiment of FIGS. 4A-B, an obstacle course 400 includes a second section 408 extending laterally away from a first section 404, and a third section 412 extending longitudinally away from the second section 408. The foregoing configurations are merely exemplary.

It is expressly contemplated that different obstacle courses may include a different number of operably connected sections having numerous configurations, each with different sections having different lateral, longitudinal, and vertical spatial relationships. It is further contemplated that each section may include independent supports (e.g., legs to support a section in a deployed state), but need not include such independent supports (e.g., in embodiments where one section supports another in a cantilevered manner).

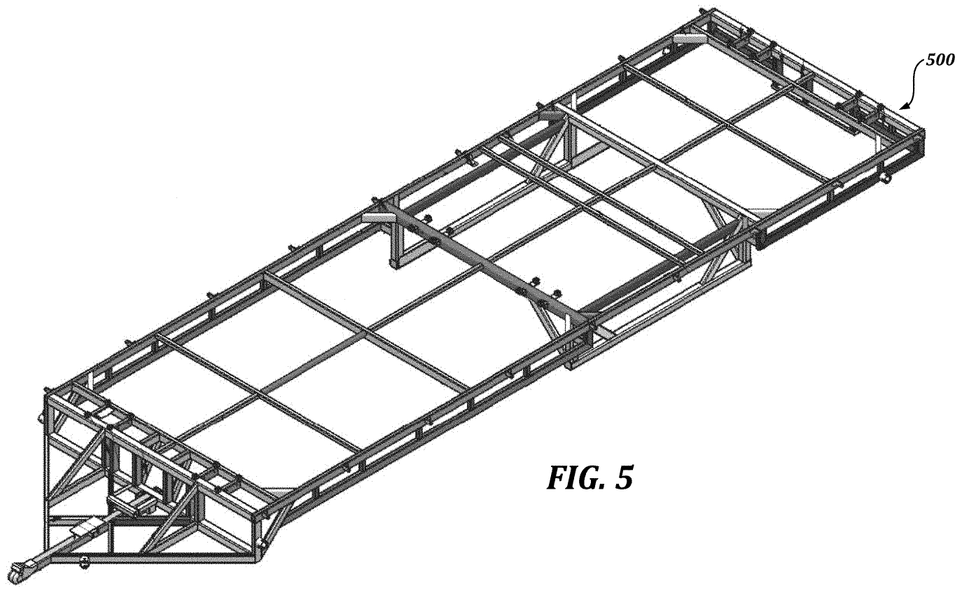

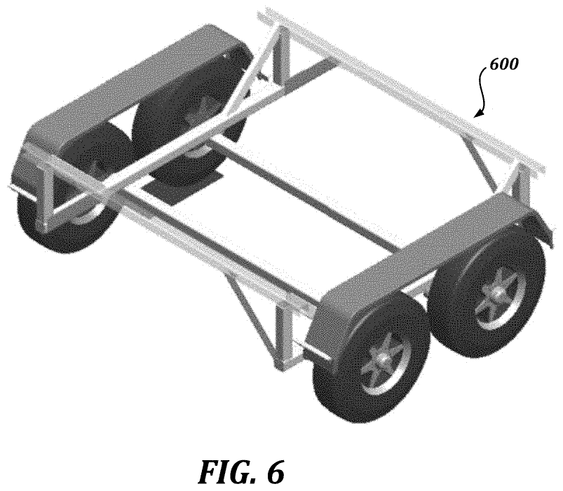

In different embodiments, the maximum size of each section may vary. Generally speaking however, the individual sections may be sized such that the entire obstacle course remains mobile. For example, each section may be sized such that the obstacle course has (as a whole), in a state configured for transportation, a total length that is between approximately twenty feet and sixty feet (excluding an attached vehicle); a total width that is between approximately six feet and ten feet; and a total height that is less than approximately fifteen feet. By comparison, when the obstacle course is in a deployed state, the maximum outer dimensions of the obstacle course as a whole may be significantly larger, as larger and more numerous sections may contribute to a more challenging and appealing obstacle course (all else equal). For example, an obstacle course may have two, three, four, or five connected sections, with each section sized and configured such that the obstacle course as a whole may fit upon a chassis or trailer (such as a chassis 500 as shown in FIG. 5, which may be mounted upon a wheel assembly 600 as shown in FIG. 6). Any road-going chassis, carriage, or vehicle or other structure preferably includes a sufficient number of axles and/or wheels to legally transport the obstacle course, along with braking and signaling systems.

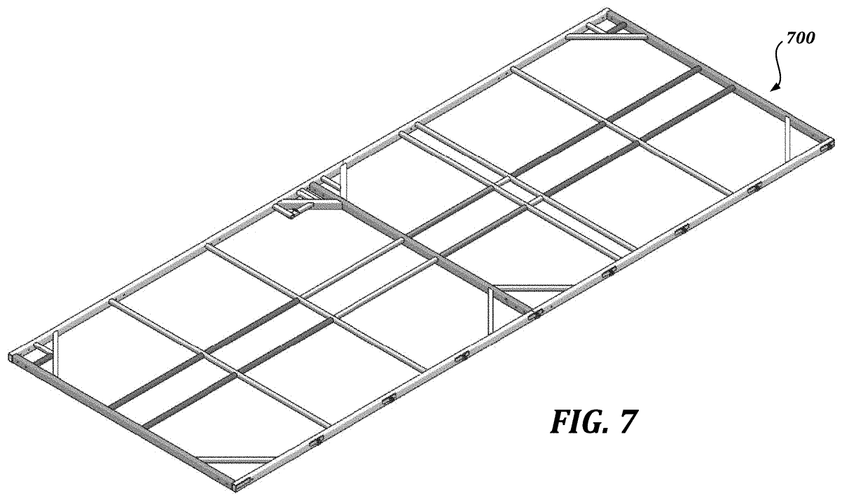

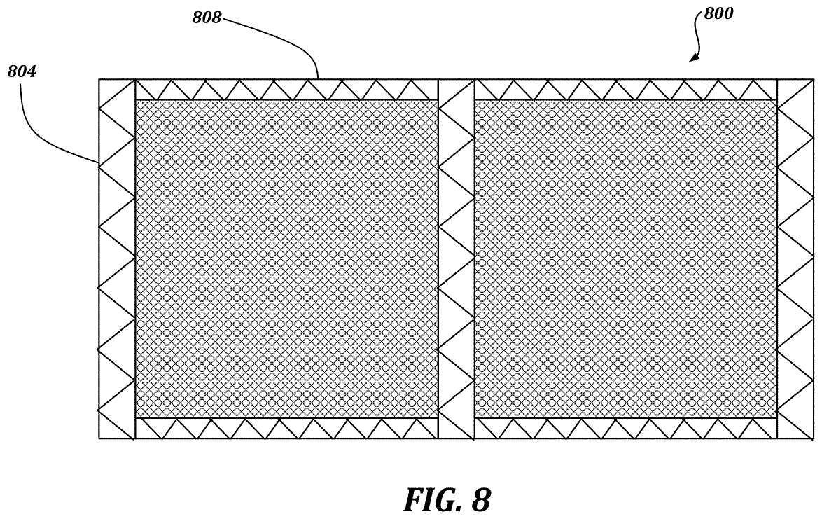

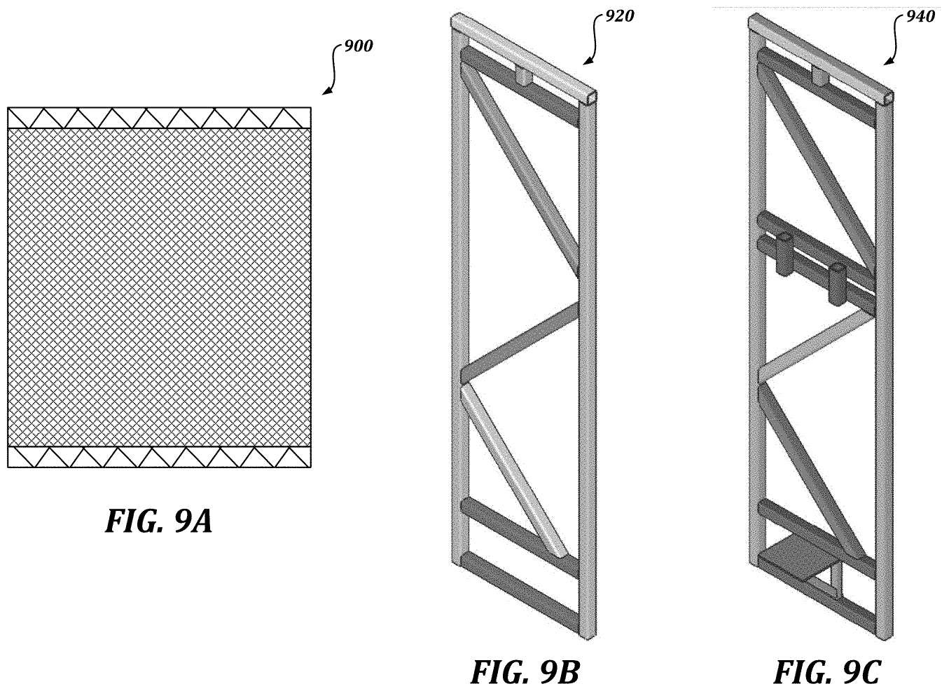

Generally, each obstacle course section may include a floor (such as a floor 700 shown in FIG. 7) and one or more frames. Each frame may include one or more side portions (such as a side portion 800 shown in FIG. 8), end portions (such as end portions 900, 920, and 940 shown in FIGS. 9A-C, respectively), and other portions. The floors and frames of each section may be configured to support one or more obstacles. Each floor may have a rectangular, square, triangular, trapezoidal, semicircular, circular, elliptical, oblong, hyperbolic, pentagonal, hexagonal, octagonal, non-geometric (e.g., an organic shape or natural shape that defies description by conventional geometric shapes), or other shape. Each floor may have an area ranging from approximately forty square feet to approximately 1,000 square feet. For example, referring to FIG. 1A, the first section 14 may include a rectangular first floor 26 measuring approximately 25 feet by 9 feet (225 square feet), the second section 18 may include a rectangular second floor 30 measuring approximately 25 feet by 2-10 feet (50-250 square feet), and the third section 22 may include a rectangular third floor 34 with dimensions similar to the first section. Generally, a larger floor area may be able to support a larger number of obstacles, and therefore may correlate with a larger, more challenging, and more appealing obstacle course. As mentioned above, each floor may support one or more obstacles, walls, timing systems, scoreboards, advertisements, graphics, or other features, such as those described above. For example, a floor may support a number of obstacles on one side, and may also support advertisements and/or graphics on another side that become visible when the obstacle course is in a transport state. Each section may include additional structure to enable modular connection to additional sections or obstacle courses.

Each frame of each section may be expandable as more fully described below (i.e., may expand from a relatively small transport state to a relatively large deployed state), and may support one or more obstacles, walls, timing systems, scoreboards, advertisements, graphics, or other features, such as those described above. The floor and/or frame of each section may define an outer volume of that section (i.e., an outer spatial envelope that each section may fit within), although the frame need not define the outer volume in all embodiments (e.g., in embodiments where the frame does not extend to the full height of the obstacle course). Generally, a frame may include a plurality of frame elements, including beams, bars, columns, risers, trusses, and/or other similar frame elements, any one or more of which may be movably connected with other frame elements (e.g., via one or more hinges or other connecting structure). The relative positions of the frame elements may vary, for example between a transport state and a deployed state and potentially along a continuum of intermediate states, described below. Generally at least some, if not a majority or entirety of the frame elements may remain contained within or upon the obstacle course in both the transport and deployed states. The obstacle course may include hardware (e.g., braces, latches, locks, straps, cables, etc.) to retain the various frame elements and other components of the obstacle course in the transport state and/or deployed state.

In a transport state, one or more frame elements of each section may fold, collapse, stow, pack, nest, consolidate, reposition, adjust, and/or otherwise transition into a position such that a majority or all of the frame elements together may occupy a smaller space than in a deployed state. For example, in a transport state, one or more frame elements may be repositioned near a floor, wall, or other component of a section. Additionally or alternatively, one or more frame elements may be moved toward a center area or other area of the obstacle course (as a whole). By comparison, in a deployed state, one or more frame elements may unfold, raise, unpack, be erected, swing outward, extend, stretch, and/or otherwise transition into a configuration or position such that the frame occupies a larger space or volume than in the transport state. As a consequence, the outer volume of each section may vary between a deployed volume and a transport volume. Each individual section may be characterized by a ratio between its deployed volume and transport volume, e.g., 1.5, 2.0, 2.5, 3.0, 3.5, 4.0, 4.5, 5.0, 6.0, 7.0, 8.0, 9.0, 10.0, 11.0, 12.0, 15.0, 20.0, or a greater ratio. As one non-limiting example, one section may have a deployed outer volume of approximately 1,575-2,925 cubic feet when its side portion, end portions, and floor are all perpendicular to each other and a transport volume of approximately 225-675 cubic feet when the end portions are folded inward, the side portion is folded toward the floor, and the floor is folded upward toward another section: a 2.3-13.0 ratio. The foregoing dimensions are not limiting, but intended to show that the sections of the obstacle courses described herein may advantageously expand from a relatively small transport volume to a relative large deployed volume. All else equal, sections with a greater ratio between the deployed volume and transport volume may provide greater commercial value because such structures enable larger (and potentially more entertaining) obstacle courses to be transported on any given vehicle.

Referring again to the non-limiting embodiment of FIGS. 1A-B, the first section 14 includes an expandable first frame 38 and the third section 22 includes a similar expandable third frame 42. Structure described herein with respect to the first frame 38 may also be true with respect to the third frame 42. The first frame 38 includes a side portion 46 (such as shown in FIG. 8) and two end portions 50, 54 (such as shown in FIG. 9A). The side portion 46 is labeled as such for reference purposes only, as it may correspond with one side of a vehicle that transports the obstacle course. Likewise, the end portions 50, 54 may correspond with the front and/or rear ends of a vehicle. The foregoing labels are merely for reference purposes, and shall not be construed as requiring any specific vehicle, orientation, or dimension.

The expandable first frame 38 includes a plurality of vertical members and horizontal members (such as a vertical member 804 and a horizontal member 808 of the side portion 800 in FIG. 8). At least some of the vertical and horizontal members may move relative to one another, e.g., via hinges or other connecting structure. For example, to configure the first frame 38 in a transport state, at least some vertical and horizontal members of the side portion 46 may rotate and/or pivot relative to the end portions 50, 54 by rotating toward the first floor 26 to set the frame 38 in the transport state. Additionally, at least some other vertical and horizontal members of the end portions 50, 54 may rotate toward the second section 18 (i.e., relative to the side portion 46).

Unlike the first and third sections 14, 22, the second section 18 of FIGS. 1A-B includes a non-expandable second frame 58 that includes one or more end portions (such as the end portions 920, 940 shown in FIGS. 9B-C, respectively) that may interface with one or more elements of the first and third frames 38, 42. The first floor 26 and the first frame 38 define the outer volume of the first section 14 (i.e., a spatial envelope in which the first section 14 may fit). The outer volume may vary between approximately 25 feet by 9 feet by 7-13 feet in a deployed state and 25 feet by 9 feet by 1-3 feet in a transport state; the second floor 30 and the second frame 58 define the maximum outer volume of the second section 18, which measures approximately 25 feet by 2-10 feet by 7-13 feet; and the third floor 34 and the third frame 42 define the maximum outer volume of the third section 22, which has dimensions similar to the first section 14 in this embodiment. Although the first and third sections 14, 22 are dimensionally and structurally similar in FIGS. 1A-B, this is not required in all embodiments. Likewise, other embodiments need not have a central, non-expandable second section.

Generally, sections of the obstacle courses may be operably connected so that the obstacle course as a whole (along with the individual sections) is movable between a first state (i.e., a transport state) and a second state (i.e., a deployed state). In some embodiments, the obstacle course may be movable along a continuum of intermediate states in between the first and second states. The first state may correspond with a collapsed state, a folded-up state, and/or a transport state in which the obstacle course is configured to move or to be moved, e.g., by a vehicle. In the first state, the obstacle course (as a whole) may have a first footprint, i.e., may cover a first area of the ground. The first footprint may generally be less than or equal to approximately 1,000 square feet (e.g., approximately 500, 300, 250, 240, 230, 220, 210, 200 square feet, or a smaller area). As one non-limiting example, the obstacle course 10 of FIGS. 1A-B may have a first footprint that is approximately 8.5 feet by 28 feet, or approximately 238 square feet. The first footprint may include all ground areas covered by the obstacle course, and is not necessarily limited to aspects of the obstacle course that literally touch the ground. In the first state, the entire obstacle course may have a first outer volume that is at least as large as the sum of the outer volumes of the individual sections in the first state. Different obstacle courses may have outer volumes in the first state that are less than or equal to approximately 15,000 cubic feet (e.g., approximately 10,000; 5,000; 4,000; 3,500; 3,250; 3,100; 3,050; 3,025; 3,000 cubic feet; or a smaller volume).

As discussed above, the obstacle course (as a whole) may assume a second state, which may correspond with an expanded state or a deployed state in which the obstacle course is configured to be used as an obstacle course. In the second state, the obstacle course may have a second footprint that is larger than the first footprint. For example, obstacle courses may have a second footprint of at least approximately 500 square feet (e.g., approximately 750; 1,000; 1,250; 1,500; 1,750; 2,000; 2,500; 5,000 square feet; or greater area). As one non-limiting example, the obstacle course 10 of FIG. 1 may have a second footprint that is approximately 35 feet by 29 feet, or approximately 1,015 square feet. In the second state, the entire obstacle course may have a second outer volume that is at least as large as the first outer volume, for example at least approximately 5,000 cubic feet (e.g., approximately 10,000; 12,500; 15,000; 17,500; 20,000; 30,000; 40,000; 50,000 cubic feet, or footage larger volume).

The obstacle course as a whole may be characterized by a ratio between the second footprint and the first footprint, e.g., 1.5, 2.0, 2.5, 3.0, 3.5, 4.0, 4.5, 5.0 or a greater ratio. As one non-limiting example, an obstacle course may have a first footprint of approximately 225-250 square feet and a second footprint of approximately 1,000-1,050 cubic feet: a 4.0-4.7 ratio. Generally speaking, a higher ratio between the second footprint and the first footprint may advantageously provide an obstacle course with greater appeal and revenue potential. The obstacle course as a whole may be further characterized by a ratio between its outer volume in the second state (i.e., its deployed volume or spatial envelope that the obstacle course may fit within) and its outer volume in the first state (i.e., its transport volume), e.g., 1.5, 2.0, 2.5, 3.0, 3.5, 4.0, 4.5, 5.0, 5.5, 6.0, 6.5, 7.0, 7.5, 8.0, 9.0, 10.0 or a greater ratio. As one non-limiting example, an obstacle course may have a first outer volume of approximately 2,900-3,100 cubic feet and a second outer volume of approximately 14,900-15,100 cubic feet: a 4.8-5.2 ratio.

In the first state, an obstacle course may have maximum outer dimensions that are sufficiently small to enable the obstacle course to fit at least partially upon, or at least partially within, or to be towed behind, a vehicle, e.g., an automobile (such as a truck), a boat, an aircraft, or another vehicle. Or, the obstacle course may include sufficient systems (e.g., a source of motive power, braking, steering, signaling, and safety systems) and may have sufficiently small outer dimensions to enable the obstacle course to move under its own power, e.g., on public roadways.

If the obstacle course is configured to be moved by a vehicle in the first state (i.e., the transport state), then the outer dimensions may be sufficiently small to enable the obstacle course to be transported on public roadways. For example, the total length of the obstacle course (excluding a vehicle) may be between approximately twenty feet and sixty feet (e.g., 25, 26, 27, 28, 29, or 30 feet); the total width may be between approximately six feet and ten feet (e.g., 6.5, 7.0, 7.5, 8.0, 8.5, 9.0, or 9.5 feet); and the total height is less than approximately fifteen feet (e.g., 11.0, 12.0, 12.25, 12.5, 12.75, or 13.0 feet). These dimensions may enable a portion, a majority, or an entirety of the obstacle course to be supported by a chassis or a trailer (preferably a road legal trailer). The obstacle course may further have a maximum weight that is calculated to enable the transporting vehicle (including a trailer, where applicable), to maintain a legal gross combined weight rating. For example, if the mobile obstacle course is supported by a trailer (such as a wheel carriage shown in FIG. 6) or upon a vehicle chassis, it may have a Gross Vehicle Weight Rating not in excess of approximately 5,000; 6,000; 7,000; 8,000; 9,000; 9,500; 9,600; 9,700; 9,800; 9,900; 10,000; 11,000; 12,000; 13,000; 14,000; 15,000; 25,000; 26,000; or 30,000 pounds).

To enable movement between the first and second states (and potentially additional states), at least two sections of the obstacle courses may be operably connected in a number of configurations. For example, adjacent sections may be connected by one or more hinges, swivels, joints, pinned supports, pinned connections, links, bearings, and/or other similar connecting structures that enable connected elements to move relative to each other along a continuum. Additionally or alternatively, sections may be connected by one or more structures that enable the connected elements to assume discrete relative positions, rather than along a continuum. For example, adjacent sections may be connected by one or more male-female connections (e.g., tongue-and-groove structures), or one or more structures that enable the sections to achieve different heights (e.g., risers and/or columns). In still other embodiments, different sections may translate relative to one another, e.g., on track systems, rack-and-pinion systems, or similar systems. For example, in the first state, the sections may reside at least partially on top of one another in order to consolidate the footprint of the obstacle course; in the second state, the sections may translate laterally relative to one another, e.g., deploy outwardly on rack systems, in order to expand the footprint of the obstacle in the second state.

By way of example, in the embodiment of FIGS. 1A-B, the first and second sections 14, 18 are connected by hinges along lower horizontal edges of the first and second sections 14, 18. In the alternative embodiment of FIG. 3, the first section, second section, and third sections 304, 308, 312 are connected by hinges secured along vertical edges of each section. In the alternative embodiment of FIG. 4, hinges connect the long sides of the first section and second sections 404, 408, while hinges also connect the short sides of the second and third sections 408, 412. The foregoing connection structures are merely exemplary, and different embodiments may include sections that are connected with different structures.

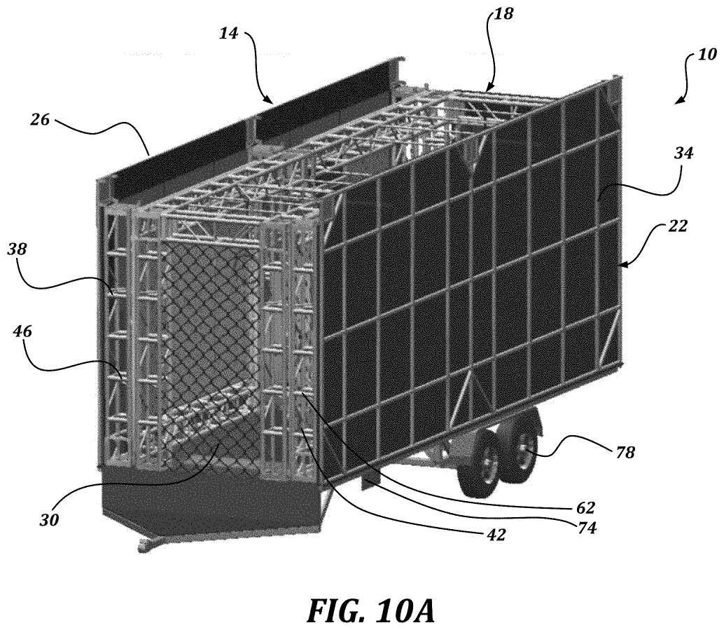

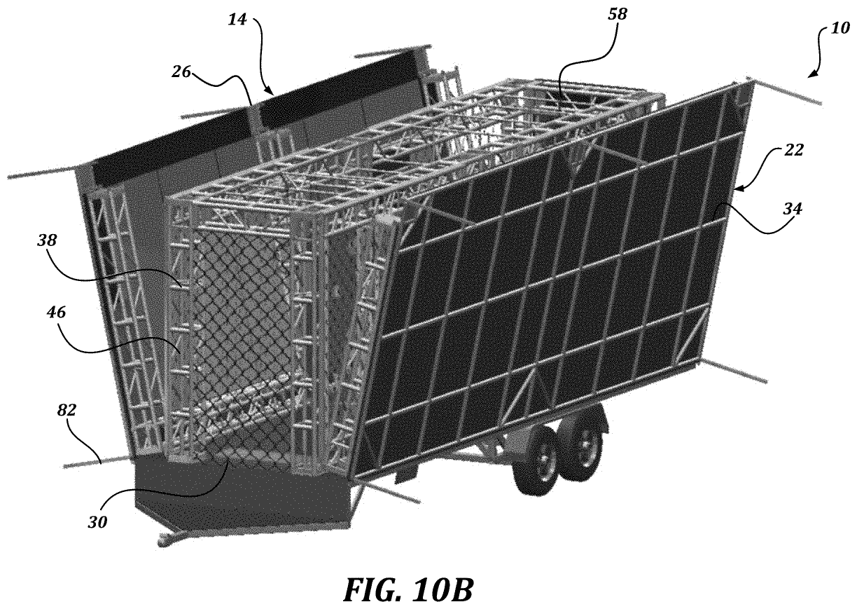

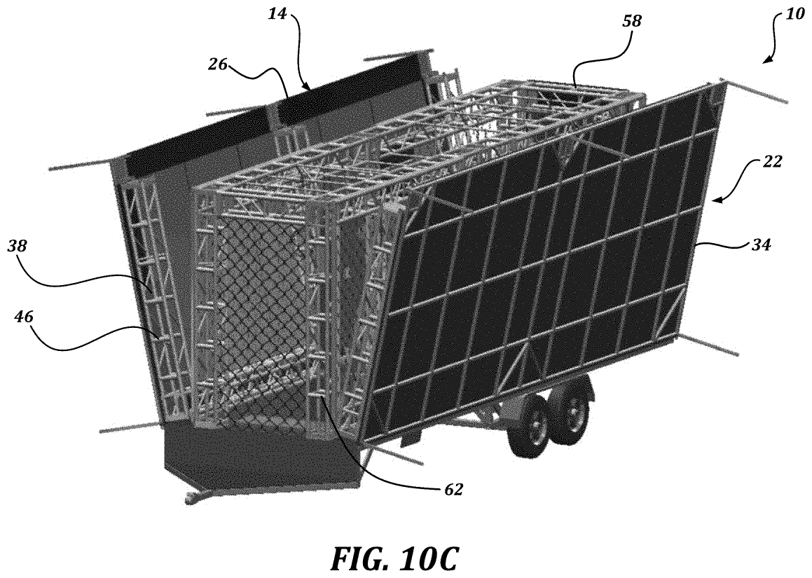

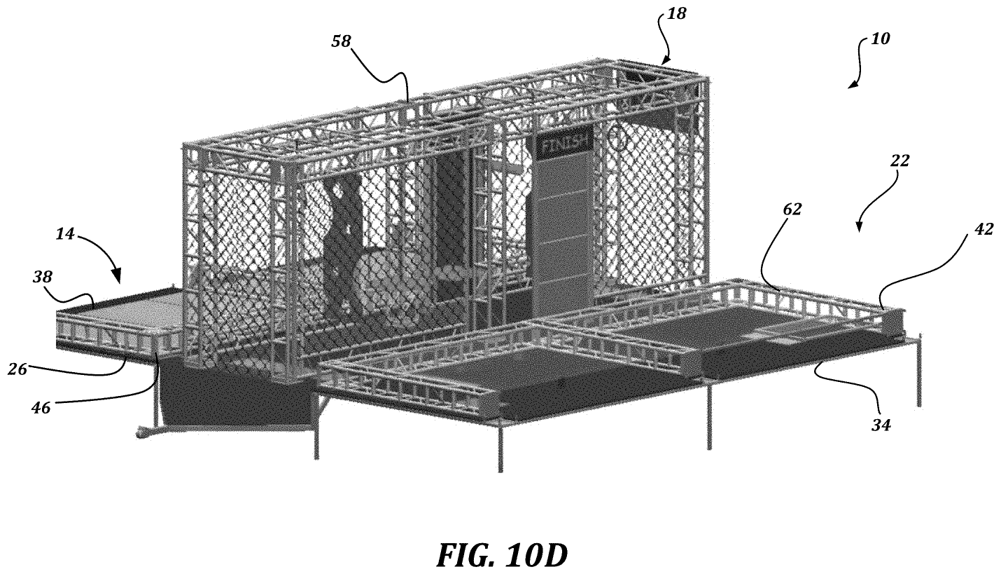

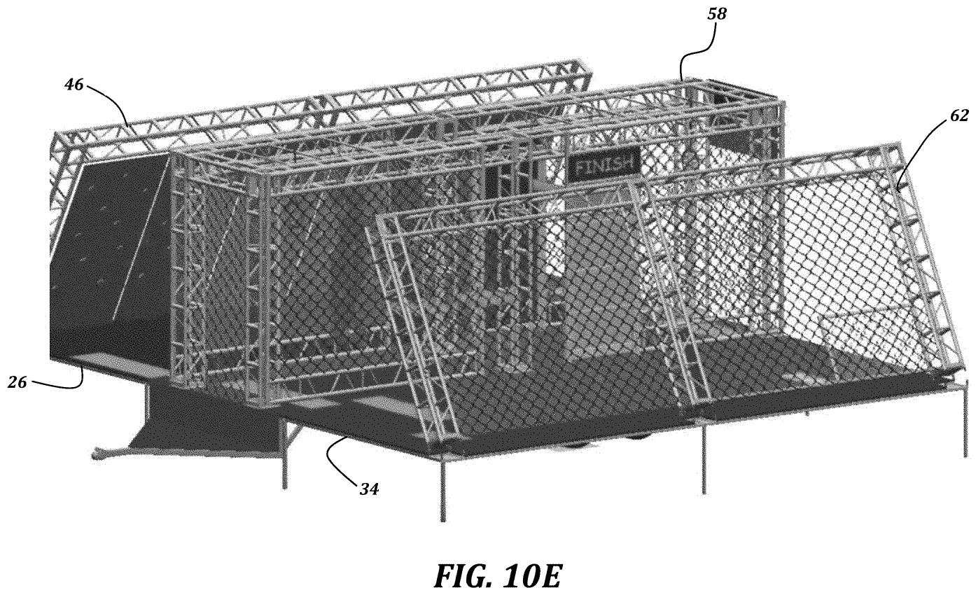

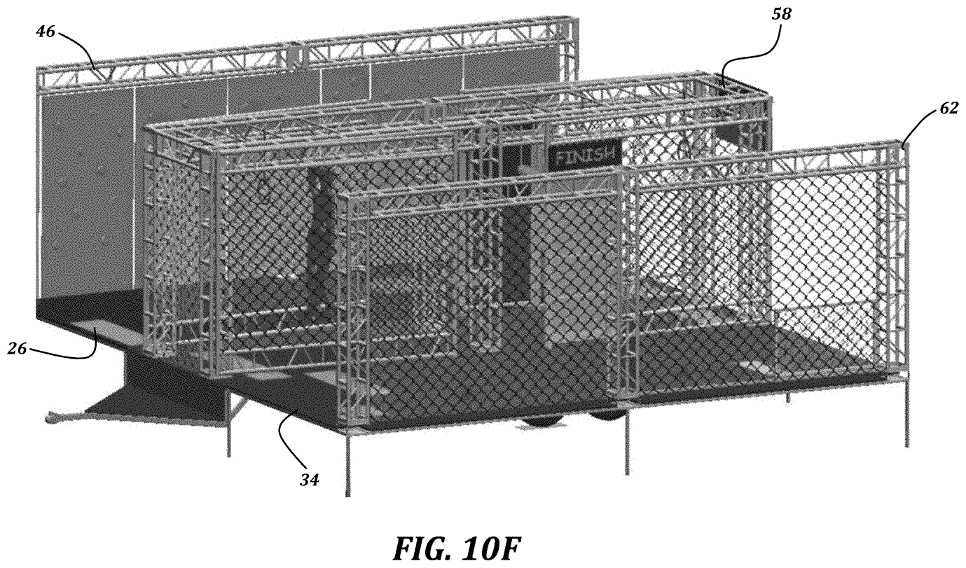

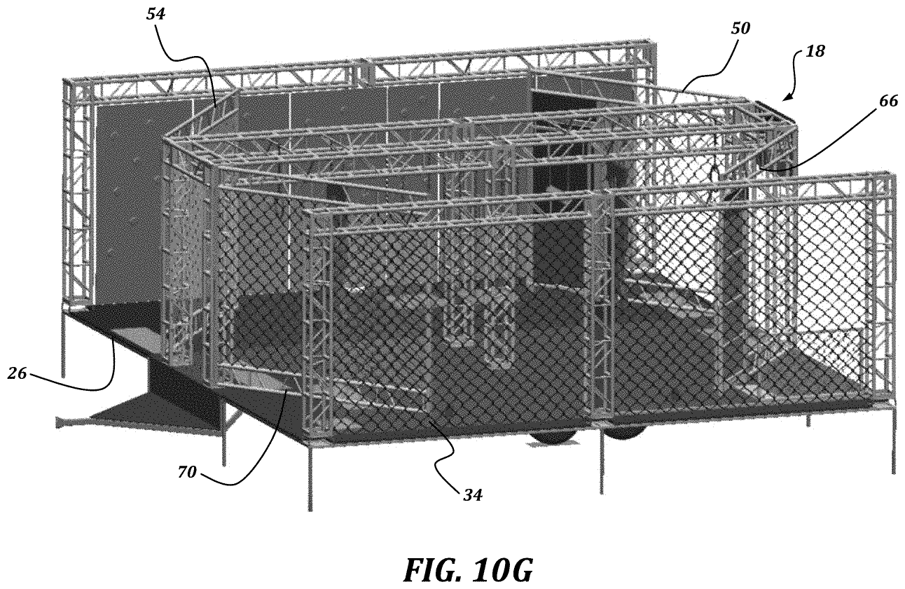

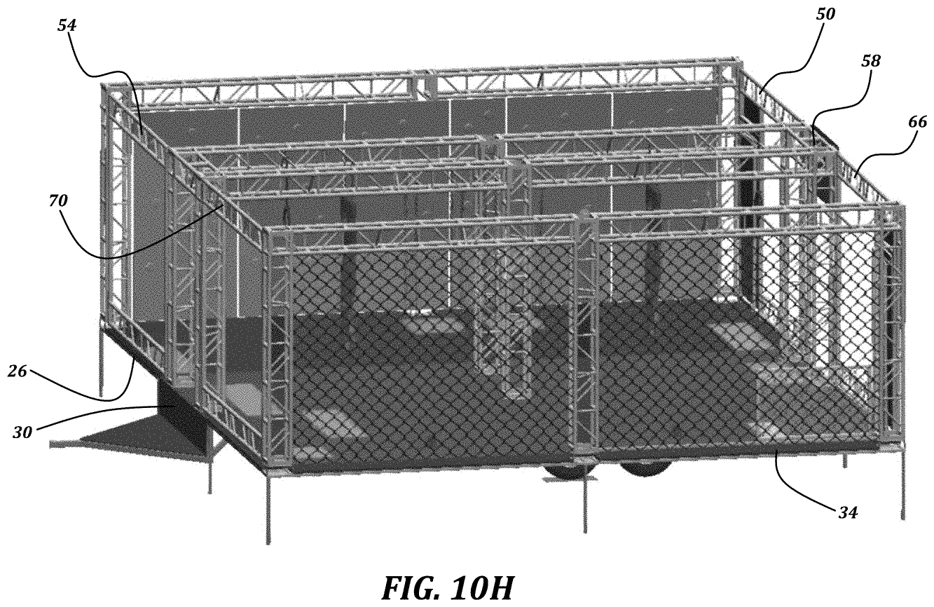

FIGS. 10A-H (with additional reference to the Appendices) illustrate the obstacle course 10 of FIGS. 1A-B in a first state, a second state, and in various intermediate states. The obstacle course 10 includes the first section 14 (with the first frame 38), the second section 18 (with the second frame 58), and the third section 22 (with the third frame 42) in a winged configuration. When the obstacle course 10 is in the first state (e.g., the transport state) versus the second state (e.g., the deployed state), the different sections may interact with each other differently, depending on how the obstacle course is configured. For example, FIG. 10A shows the obstacle course 10 in a “wings up” transport state, in which it is configured to roll on a wheel carriage 78 behind a towing vehicle. In this state, the first and third frames 38, 42 are folded up and secured for transportation, for example by folding side portions 46, 62 downward toward the first floor 26 and the third floor 34, respectively. In the transport state, the first floor 26 and third floor 34 are within fifteen degrees of parallel with each other. The first floor 26 and the third floor 34 are also within fifteen degrees of perpendicular of the second floor 30 of the second section 18 in the transport state, as both are folded upwards. Characterized another way, the first section 14 and the third section 22 each interface with opposite sides of the second section 18 in the transport state. Characterized yet another way, both the first, second, and third sections 14, 18, 22 have a vertical orientation in the transport state; this is because the second section 18 has tall and slender dimensions and because the first and third sections 14, 22 are turned upward with their frames collapsed. Indeed, the entire obstacle course 10 has an aspect ratio (i.e., height divided by width) that exceeds 1.0 in the transport state because its height exceeds its width. In the transport state, the obstacle course 10 is configured to be moved by a vehicle. For this reason, the obstacle course 10 is mounted upon a chassis 74 (such as shown in FIG. 5) and the wheel carriage 78 (such as shown in FIG. 6) to facilitate towing. The obstacle course 10 includes two axles to distribute the weight of the obstacle course 10; however, other embodiments may have a single axle or a greater number of axles.

FIGS. 10B-C show the obstacle course 10 in numerous intermediate states between the transport state and the deployed state. For example, FIGS. 10B-C show that the first and third sections 14, 22 have begun rotating downward via hinges toward the deployed “wings down” state. Foldable legs 82 (which may alternatively be jacks or similar supports) positioned on the bottom of each of the first and third floors 26, 34 are deployed in preparation to at least partially support the first and third sections 14, 22 in the deployed state. In this state, the first floor 26 and the third floor 34 are no longer parallel with each other nor perpendicular to the second floor 30.

FIGS. 10D-H show the obstacle course 10 in additional intermediate states, wherein the first and third floors 26, 34 are in a “wings down” state, but wherein the first and third frames 38, 42 are in various stages of partial deployment. For example, in FIG. 10D, side portions 46, 62 of the first and third sections 14, 22, respectively are folded downward onto the first and third floors 26, 34, respectively. By comparison, in FIG. 10E, the side portions 46, 62 are partially rotated upward and away from the first and third floors 26, 34 (e.g., via hinges), respectively. In FIG. 10F, the side portions 46, 62 are fully rotated upward and away from the first and third floors 26, 34, respectively. Consequently, the side portions 46, 62 are approximately perpendicular with the first and third floors 26, 34 in FIG. 10F. Notably, in FIG. 10F, end portions 50, 54 of the first section 14 and end portions 66, 70 of the third section 22 are still stowed and/or folded. While the end portions 50, 54, 66, 70 are hingeably connected to the second section 18 in FIGS. 10A-H (in order to reduce the weight of each side portion 46, 62), similar end portions could alternatively be connected to the side portions and/or the floors of the first and third sections in other embodiments.

In FIG. 10G, the end portions 50, 54, 66, 70 are partially rotated outwardly away from the second section 18 toward their fully deployed positions. In FIG. 10H, the end portions 50, 54, 66, 70 are fully rotated away from the second section 18 via hinges and secured in the fully deployed position, such as with braces, bolts, connectors, fasteners, locks, and/or similar mechanisms. In the fully deployed position, the end portions of each section may be perpendicular to both the floor and side portions of that section, and the end portions and side portions may together form a perimeter around the obstacle course that may help keep participants inside the obstacle course. In the deployed state shown in FIG. 10H, the first floor 26, the second floor 30, and the third floor 34 may be within fifteen degrees of parallel of each other. In this state, the obstacle course 10 has an aspect ratio that is less than 1.0 because its width exceeds its height.

It shall be appreciated that the embodiment shown in FIGS. 10A-H is merely exemplary, and that other embodiments may include different configurations. For example, other obstacle courses may include greater or fewer connected sections. Further, each section may include a frame that is configured differently than the frame shown in FIGS. 10A-H. For example, in alternative embodiments, a frame may lack one or more of the vertical or horizontal beams, trusses, or other frame elements shown in FIGS. 10A-H, as it is foreseeable that netting or other non-load-bearing members may substitute for one or more frame elements. Additionally or alternatively, in alternative embodiments, a frame may include one or more additional frame elements, e.g., for added strength. As another example, one or more frame elements may nest or stow in different configurations than shown in FIGS. 10A-H.

It may be commercially advantageous to quickly transition the obstacle course from the first state to the second state (or to additional states), so that participants may enter the obstacle course soon after the obstacle course arrives at an event site. To facilitate a rapid transition from the first state to the second state and to reduce safety risks, the obstacle course may include one or more force assist systems, e.g., a hydraulic system, a winch and pulley system, a spring system, an electric actuator system, a gearbox, and/or other force assist system. For example, an operator may selectively attach the winch cable to different aspects of the obstacle course, and then may selectively lower and raise each of the first and third sections in a safe, controlled manner. The operator may further utilize the winch to raise and lower elements of an expandable frame or other components of the obstacle course. The obstacle course may include one or more jacks or other supports that stabilize the obstacle course in the deployed state. Preferably, the force assist system may enable one or two operators to safely transition the obstacle course from the first state to the second state in less than one hour, e.g., less than fifty minutes, forty minutes, thirty minutes, twenty minutes, ten minutes, or five minutes.

Referring to FIGS. 10A-H in sequence, along with the Appendices, one exemplary method for entertaining includes a step of transporting the obstacle course 10 to an event site, such as by towing it behind a vehicle. The method further includes transforming the obstacle course 10 from a transport state to a deployed state. Transforming the obstacle course 10 includes a first step of selecting a flat, level, and firm operating surface on which to deploy the obstacle course 10. Then, if the obstacle course 10 is attached to a vehicle, the obstacle course may be unhitched or detached from the vehicle and supported by one or more foldable legs 82 or jacks. Then, a winch cable may be secured to the first section 14, e.g., to an eye hook on the first floor 26. Then, the second section 18 may be stabilized with one or more jacks. Then, the first section 14 may be unsecured from the second section 18 (e.g., by disconnecting any support braces or similar structure). Then, with the winch cable secured to the first section 14, the winch may be operated to slowly lower the first section 14 from a vertical “transport” position to a horizontal “deployed” position. When the first section 14 is in the horizontal position, then support jacks may be lowered to stabilize the first section 14. Then, the winch cable may be unhooked from the first section 14 and then secured to the third section 22 (e.g., to an eye hook on the third section 22). Then, the winch may be operated to slowly lower the third section 22 from the vertical position to the horizontal position, and support jacks may be deployed to stabilize the third section 22.

Once both the first and third sections 14, 22 are in the horizontal positions, then one, two, or more workers may raise the side portion 46 of the first section 14, e.g., by rotating it upward and away from the first floor 26 so that it becomes perpendicular with the first floor 26. The side portion 46 may then be secured to the first floor 26, e.g., with bolts. Then, the first and second end portions 50, 54 may be swung away from the second section 18 and secured to the side portion 46. This process may then be repeated for the side portion 62 and end portions 66, 70 of the third section 22. An additional winch or force assist system may be utilized to assist with the steps of raising one or more of the side portions 46, 62, especially if either or both side portions support a relatively heavy obstacle, e.g., a climbing wall. Following these steps, the side portions and end gates of the first and third sections, along with the frame of the second section, together form a perimeter around the obstacle course.

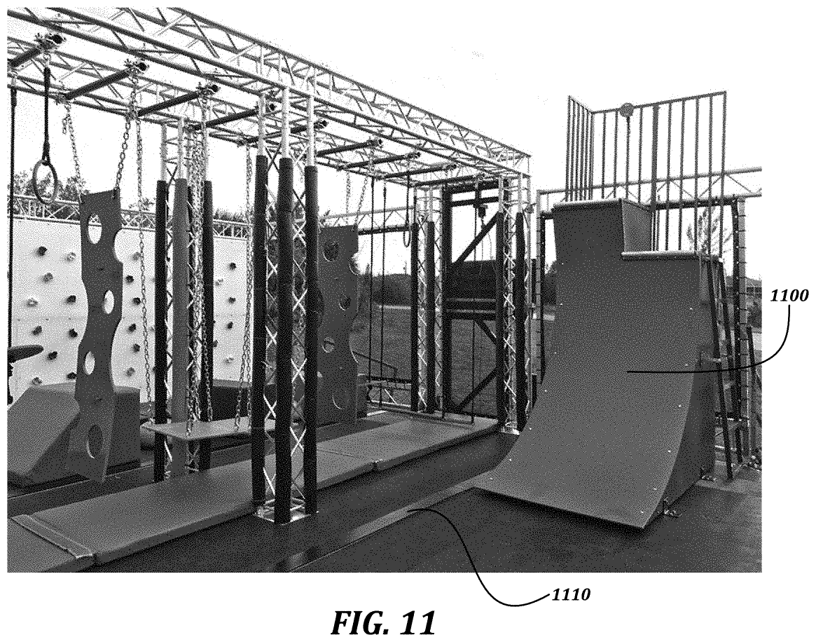

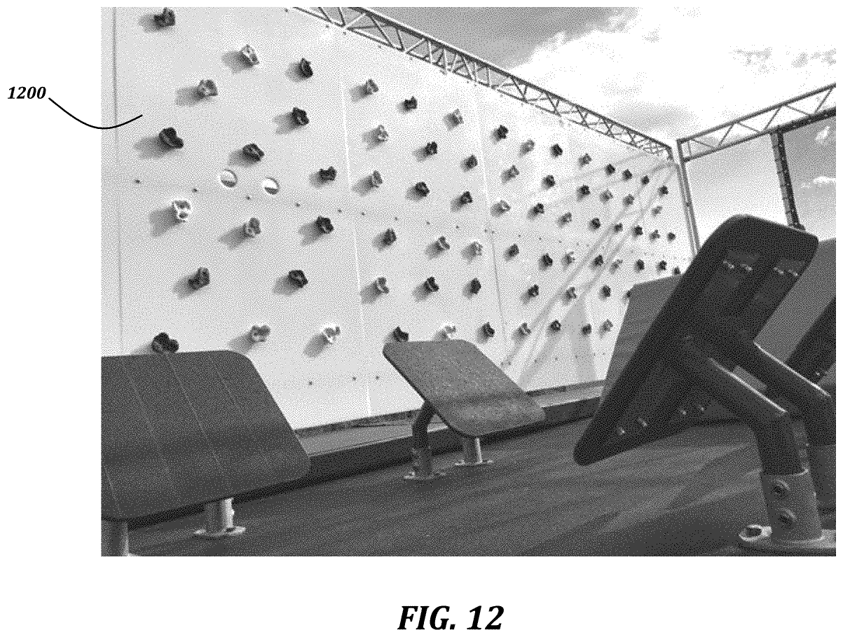

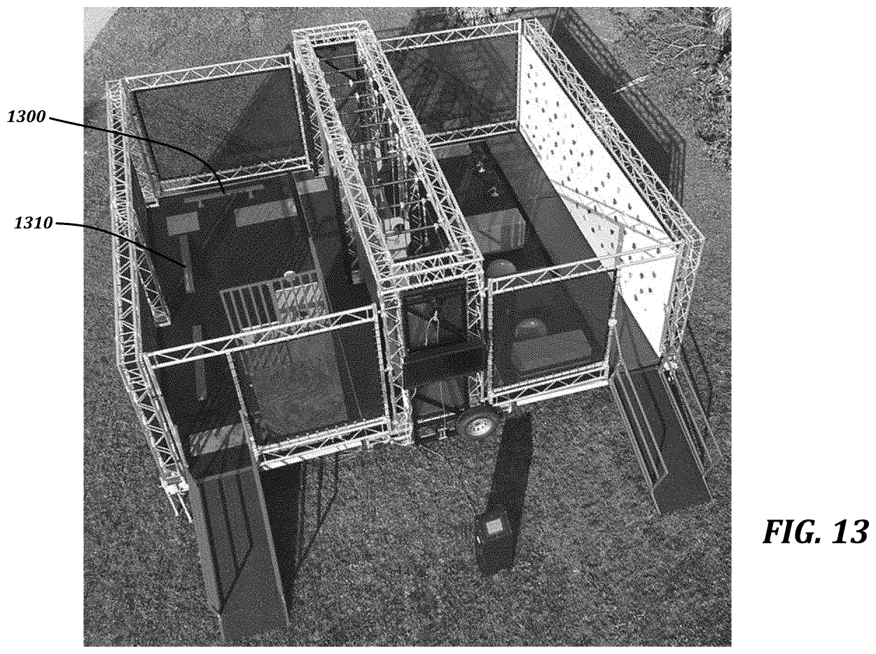

Following the foregoing steps, one or more ramps 86 may be connected to the obstacle course 86. For example, ramp 86 may be connected to openings in the end portions 50, 54, 66, and/or 70. Next, the obstacles may be set up within the obstacle course and safety devices may be placed. For example, a warped wall may be positioned on the first floor 26 or third floor 34 (such as a warped wall 1100 as shown in FIG. 11). Foam safety pads may be placed below a climbing wall that is supported by one or more side portions 46, 62 (such as a climbing wall 1200 as shown in FIG. 12). Obstacles may be suspended via chains from the frame 58 of the second section 18, e.g., a cheese board, climbing rings, dangle discs, etc., as shown in FIGS. 11 and 13. One or more balance beams and/or see-saws may be secured on the first floor 26 or third floor 34 (such as the balance beam 1300 and see saw 1310 as shown in FIG. 13). Covers may be placed over any gaps between the first, second, and third floors 26, 30, 34 (such as a cover 1110 shown in FIG. 11). A control console may be positioned nearby (as shown in FIG. 13) and connected to a power source, which may also be connected to a TV, scoreboard, smoke machine, other audiovisual equipment, and other electronics. In different embodiments, the selection and positioning of obstacles may vary significantly. Following this sequence, a complete obstacle may include a plurality of participant-facing obstacles, and all participant-facing obstacles may be contained within the first, second, and third sections 14, 18, 22.

One exemplary procedure for transforming the obstacle course from a deployed state to a transport state (i.e., taking it down) would include executing the foregoing steps in reverse (e.g., raising the first and third sections 14, 22 with the winch), and in roughly reverse order (e.g., folding the end portions 50, 54, 66, 70 prior to raising the first and third sections 14, 22).

Following safe setup, the obstacle course 10 may be opened for use. One or more participants may “challenge” the obstacle course 10, for example by racing a clock to complete the course in the lowest possible time. The participant's time and other real-time information may be displayed via a scoreboard and/or monitor, along with audiovisual effects that encourage spectators to cheer on the participants, and to foster competition. For example, a participant may enter the obstacle course 10 via an opening in the end portion 50 of the first section 14. The participant may then traverse obstacles in the following non-limiting order: a climbing wall supported by the first side portion 46; then one or more parkour steps and/or parkour blocks and/or balance balls supported upon the first floor 26; then one or more swings, hand rings, hand bombs, dangle discs, floating platforms, and cheese boards supported by the frame 58 of the second section 18; then one or more balance beams and/or see-saws and/or warped walls supported by the third floor 34. When the participant reaches the top of a warped wall, she or he may stop the clock by triggering a smoke cannon or other trigger. The participant may then exit the obstacle course through an opening in the end portion 66 of the third section 22.

While various embodiments of the present disclosure have been described, the present disclosure is not to be restricted except in light of the attached claims and their equivalents. Rather, the embodiments discussed were chosen and described to provide the best illustration of the principles of the present disclosure and its practical application to thereby enable one of ordinary skill in the art to utilize the present disclosure in various forms and with various modifications as are suited to the particular use contemplated. It is intended and will be appreciated that embodiments may be variously combined or separated without departing from the present disclosure and all exemplary features described herein are applicable to all aspects of the present disclosure described herein. Moreover, the advantages described herein are not necessarily the only advantages of the present disclosure and it is not necessarily expected that every embodiment of the present disclosure will achieve all of the advantages described.

The embodiments of the invention in which an exclusive property or privilege is claimed are defined as follows:

1. A mobile obstacle course, comprising:
an expandable structure that is supported by a wheeled chassis, contains a plurality of obstacles therein, and configured to move between a transport state and a deployed state, the expandable structure comprising:
a central obstacle area;
an outer obstacle area that is connected to the central obstacle area in the transport state and in the deployed state;
wherein in the transport state, the expandable structure has a first footprint based upon an area of a floor of the central obstacle area,
wherein in the deployed state, the expandable structure has a second footprint that is larger than the first footprint, the second footprint being based upon the area of the floor of the central obstacle area and an area of a floor of the outer obstacle area.

2. The mobile obstacle course of claim 1, wherein the outer obstacle area is hingeably connected to the central obstacle area, and the expandable structure is configured to move between the transport state and the deployed state by rotating the outer obstacle area away from the central obstacle area until the floor of the central obstacle area is parallel to the floor of the outer obstacle area.

3. The mobile obstacle course of claim 2, further comprising a second outer obstacle area that is hingeably connected to the central obstacle area, wherein the second footprint is also based upon an area of a floor of the second outer obstacle area.

4. The mobile obstacle course of claim 3, wherein the second outer obstacle area has a doorway through a wall section thereof and, in the deployed state, the plurality of obstacles form a course that begins or ends at the doorway.

5. The mobile obstacle course of claim 4, wherein the plurality of obstacles includes a wall-mounted obstacle, a hanging obstacle, and a freestanding wall-type obstacle.

6. The mobile obstacle course of claim 5, wherein the wall-mounted obstacle is a climbing wall mounted to a wall of the outer obstacle area, the hanging obstacle is suspended from a frame of the central obstacle area, and the freestanding wall-type obstacle is positioned upon a floor of the outer obstacle area.

7. The mobile obstacle course of claim 1, wherein the outer obstacle area is associated with a plurality of collapsible frame elements that, in the transport state, stow between the floor of the outer obstacle area and a frame of the central obstacle area, and in the deployed state, are supported perpendicular to the floor of the outer obstacle area.

8. The mobile obstacle course of claim 7, wherein the transport state, an interior space located within the frame of the central obstacle area stores at least some of the plurality of obstacles.

9. The mobile obstacle course of claim 8, wherein the plurality of collapsible frame elements includes a front wall section, a rear wall section, and an outer wall section, wherein the outer wall section is supported by the floor of the outer obstacle area and the front wall section and the rear wall section are movably supported by the frame of the central obstacle area.

10. The mobile obstacle course of claim 9, wherein to move from the transport state to the deployed state, the outer wall section is configured to pivot away from the floor of the outer obstacle area, and the front wall section and the rear wall section are configured to pivot away from the frame of the central obstacle area.

11. The mobile obstacle course of claim 7, wherein the central obstacle area is associated with a first plurality of obstacle types and the outer obstacle area is associated with a second plurality of obstacle types, the first plurality of obstacle types differing from the second plurality of obstacle types.

12. The mobile obstacle course of claim 11, wherein the first plurality of obstacle types includes a hanging obstacle that hangs from the frame of the central obstacle area and the second plurality of obstacle types includes a wall-mounted obstacle that is supported by a wall section of the outer obstacle area.

13. The mobile obstacle course of claim 2, wherein a ratio of the second footprint to the first footprint is at least 2.0.

14. The mobile obstacle course of claim 2, wherein in the transport state, the expandable structure has a first outer volume and in the deployed state, the expandable structure has a second outer volume, wherein a ratio of the second outer volume to the first outer volume is between 2.0 and 10.0.

15. The mobile obstacle course of claim 14, wherein in the transport state, the expandable structure has a length between about twenty feet and about sixty feet, a width of between about six feet and about ten feet, and a height of less than about fifteen feet.

16. The mobile obstacle course of claim 1, wherein in the transport state, the floor of the central obstacle area and the floor of the outer obstacle area are within fifteen degrees of perpendicular with each other.

17. The mobile obstacle course of claim 1, further comprising a force assist system configured to regulate a movement of the expandable structure between the transport state and the deployed state by using a cable that is attached to the outer obstacle area and is routed through the central obstacle area.

18. An obstacle course, comprising:
an expandable structure that contains a plurality of obstacles and is configured to expand from a transport state to a deployed state, the expandable structure comprising:
a central obstacle area having a central floor and a frame;
a left obstacle area that is hingeably connected to a first side of the central obstacle area in the transport state and the deployed state, the left obstacle area having a left floor; and
a right obstacle area that is hingeably connected to a second side of the central obstacle area in the transport state and the deployed state, the right obstacle area having a right floor;
wherein in the transport state, the expandable structure has a first outer volume, and the left floor and the right floor are perpendicular to the central floor,
wherein in the deployed state, the expandable structure has a second outer volume that is between 2.0 and 10.0 times larger than the first outer volume and the left floor and the right floor are parallel to the central floor.

19. The obstacle course of claim 18, wherein the left obstacle area is associated with a left wall section and the right obstacle area is associated with a right wall section, wherein the left wall section stows next to the left floor in the transport state and the right wall section stows next to the right floor in the transport state.

20. The obstacle course of claim 19, wherein the left obstacle area is associated with a left end wall section and the right obstacle area is associated with a right end wall section, both of the left end wall section and the right end wall section being hingeably supported by and configured to stow against the frame of the central obstacle area in the transport state.
